(19) United States
(12) Patent Application Publication
(10) Pub. No.: US 2018/0112772 A1
(43) Pub. Date: Apr. 26, 2018

(54) GEAR CHANGE AND SELECTION LEVER IN A MOTOR VEHICLE GEARBOX FOR A MOTOR VEHICLE

(71) Applicant: DURA AUTOMOTIVE HOLDINGS U.K., LTD, Birmingham (GB)

(72) Inventors: Sébastien Maitre, Monistrol Sur Loire (FR); Joris Nogier, Saint-Chamond (FR)

(21) Appl. No.: 15/784,518

(22) Filed: Oct. 16, 2017

(30) Foreign Application Priority Data
Oct. 24, 2016 (FR) FR1660267

(51) Int. Cl. F16H 61/24; F16H 59/04

(52) U.S. Cl. CPC F16H 61/24; F16H 2061/242; F16H 2061/243; F16H 59/04

(57) ABSTRACT

Gear change and selection lever in a mechanical motor vehicle gearbox for a motor vehicle, remarkable in that it consists of two rods in coaxial alignment, separated by a detent ball engagement member extending perpendicularly and inserted into an insert, the detent ball engagement member being intended to cooperate with a cam in order to index different positions of the lever, the rods and the insert being rendered integral by means of an overmolding in a plastic material.

### CROSS REFERENCE TO RELATED APPLICATIONS

This application claims priority to French Patent Application No.: FR1660267 filed Oct. 24, 2016. The content of this priority application is incorporated herein by reference in its entirety.

### TECHNICAL FIELD The disclosure relates to the technical field of mechanical gearboxes for motor vehicles.

More particularly, the disclosure relates to a sophisticated gear change and selection lever.

### BACKGROUND

Known in the state of the art is a gear change and selection lever for a motor vehicle gearbox, comprising, in general a way, a metallic rod whereupon elements are welded, such as for example a change finger suitable to cooperate with a selector finger notch, and an indexing body having opposing faces with cam profiles in order to allow for the indexing of various positions of the lever serving as an engagement track for two detent ball engagement members.

The lever further comprises a housing, internally comprising two detent ball engagement members, suitable for covering part of the metallic rod and the indexing member, in order to make the detent ball engagement members cooperate with the indexing members.

The design of the lever and the housing according to the prior art is complex insofar as it requires the use of mechanically welded parts, and involves sheet metal drawing, machining, cutting, laser welding, and anti-corrosion treatment steps for the rod.

Thus, in order to be commercially competitive, the machines for manufacturing these parts must be amortized for accounting purposes in order to minimize and control production costs.

In at least some implementations, the invention aims to provide a sophisticated gear change and selection lever, whereby the design is simplified, and does not require heavy investment for the manufacture thereof, in such a way that the production cost of such a lever is minimized and competitive.

To do this, a gear change and selection lever in a mechanical motor vehicle gearbox for a motor vehicle was designed and developed that is remarkable in that it consists of two rods in coaxial alignment. The two rods are separated one from the other by a detent ball engagement member extending perpendicularly in relation to the rods. The detent ball engagement member is inserted into an insert, preferably metallic, and is intended to cooperate with a cam in order to implement the indexing of the various positions of the lever. The rods and the metallic insert are rendered integral together by means of an overmolding in a plastic material.

In this way, the design is simplified. The number of parts required for the manufacture of the lever is reduced, and any welding steps are removed. The different parts are assembled and attached together by means of an overmolding, manufactured in a single operation. As a result of the lever comprising two rods, only the rod that is intended to be in contact is subjected to anticorrosion treatment, which allows for a further decrease in costs in relation to the prior art wherein the whole rod had to be subjected to anticorrosion treatment.

### SUMMARY

According to a specific embodiment, the detent ball engagement member comprises a sleeve and a ball accommodated within the sleeve, and maintained protruding at one end of the sleeve. The sleeve of the detent ball engagement member is inserted into the metal insert.

Preferably, one of the rods comprises at least a change finger protruding transversely and attached to the rod by means of an overmolding in a plastic material. In an advantageous way, a single overmolding makes it possible to integrally attach the rods, the metallic insert and the change finger/s.

Moreover, and according to another characteristic of at least some implementations of the invention, a selector finger is rendered integral to the lever by means of the overmolding of the metallic insert, the selector finger being intended to cooperate with a grid in order to act as an abutment for different positions of the lever.

According to a particular embodiment, the lever comprises a housing suitable for being fitted around one of the rods and covering the detent ball engagement member. The housing internally comprises the cam in order to serve as an engagement track for the detent ball engagement member and to allow for the indexing of the various positions of the lever, and a grid in order to cooperate with the selector finger.

### BRIEF DESCRIPTION OF THE ACCOMPANYING DRAWINGS

Further advantages and features of at least some implementations of the invention will become more apparent from the following description, given by way of a non-limiting example, of the transmission device according to the invention, from the attached drawings, wherein:

FIG. 1 is a perspective view of the gear change and selection lever according to the non-limiting example of the invention;

FIG. 2 is a perspective view similar to that of FIG. 1, the housing of the lever having been removed;

FIG. 3 is a perspective view similar to that of FIG. 2, the lever being shown in an exploded longitudinal view; and

FIG. 4 is a view similar to that of FIG. 3, illustrating in detail the overmolding of the insert receiving the detent ball engagement member and the change finger, and the cooperation of the detent ball engagement member with the cam of the housing.

### DETAILED DESCRIPTION

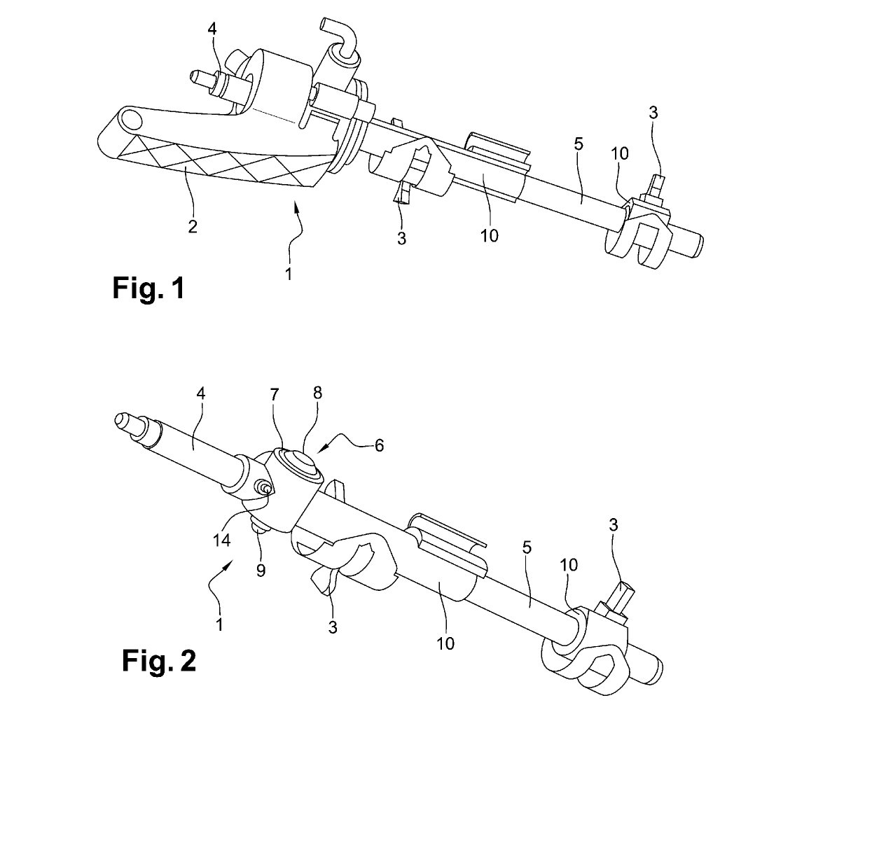

According to at least some implementations of the invention, and with reference to FIGS. 1 and 2, the gear change and selection lever (1) for a manual gearbox of a motor vehicle is surmounted by a housing (2) and includes protruding change fingers (3), whose function, well known in the prior art, is to cooperate with the selector finder notch cooperating with a fork for the translational control of a mobile gear for changing gear.

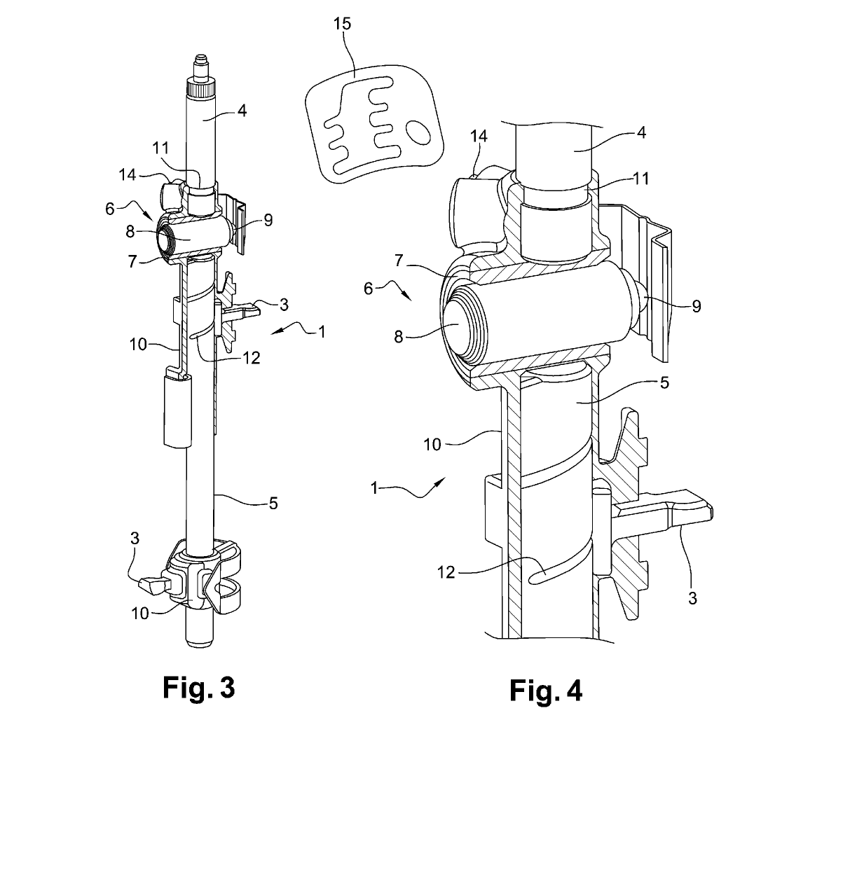

Specifically, and with reference to FIGS. 3 and 4, the lever (1) consists of two rods (4, 5) in coaxial alignment, and separated from one another by a detent ball engagement member (6) extending perpendicularly from the two rods (4, 5).

The detent ball engagement member (6) is slid into a preferably metallic and cylindrical insert (7), open at least at one of the ends thereof. The detent ball engagement member comprises a sleeve (8) internally receiving a ball (9) held within a projecting end of the sleeve (8) for example by means of a spring located within the sleeve (8). The detent ball engagement member (6) is arranged in such a way that the ball (9) protrudes from the open end of the insert (7).

The two rods (4, 5), the cylindrical insert (7) of the detent ball engagement member (6) and the one or two change fingers (3) are overmolded together and rendered integral by means of an overmolding (10) in a plastic material. In the illustrated embodiment, one change finger (3) is overmolded together with the insert (7) and the two rods (4, 5), the other change finger (3) is independently overmolded with only one rod (5).

The overmolding (10) makes it possible to perform the assembly and centering of the parts in a single step. The overmolding (10) makes it possible to perform other functions, such as for example the inclusion of interlocking and contact elements.

The rods (4, 5) comprise recessed or embossed patterns in order to allow for good performance of the overmolding (10). The rod (4) comprises, for example, an annular groove (11) and the rod (5) comprises for example a helical groove (12) wherein the plastic material is intended to remain during overmolding in order to improve stability.

One of the rods (4) and the detent ball engagement member (6) are covered by the housing (2) which is fitted around said rod (4). The housing (2) internally comprises a metallic plate with the profile of a cam (13), which is positioned such that it faces the detent ball engagement member (6) in such a way that the ball (9), which extends from the insert (7), rests against the cam (13) in order to transmit an elastic force against said cam (13) which is shaped in such a way as to act as an engagement track and to allow for the indexing of various positions of the lever (1).

With reference to FIGS. 2, 3 and 4, the lever (1) also comprises a selector finger (14), overmolded together with the rods (4, 5) and the insert (7) in order to protrude transversely at the part covered by the housing (2). The housing (2) internally comprises a grid (15) suitable to engage with the selector finger (14) in order to form abutments for the different positions of the lever (1).

The plastic overmoulding according to at least some implementations of the invention makes it possible to reduce the number of parts required for the manufacture of the lever (1), to do away with welding operations, and to assemble the different parts in a single operation. The lever (1) may have a simple, safe and rational design that makes it possible to reduce the costs of the lever

1. Gear change and selection lever in a mechanical motor vehicle gearbox for a motor vehicle, characterized in that it consists of two rods in coaxial alignment, separated by a detent ball engagement member extending perpendicularly and inserted into an insert, the detent ball engagement member being intended to cooperate with a cam in order to index different positions of the lever, the rods and the insert being rendered integral together by means of an overmolding in a plastic material.

2. Lever according to claim 1, characterized in that the detent ball engagement member comprises a sleeve internally receiving a ball held projecting within an end of the sleeve.

3. Lever according to claim 1, characterized in that one of the rods comprises at least one change finger protruding transversely and attached to the rod by means of the overmolding.

4. Lever according to claim 1, characterized in that a selector finger is rendered integral to the lever by means of the overmolding of the insert, the selector finger being intended to cooperate with a grid in order to serve as an abutment for different positions of the lever.

5. Lever according to claim 4, characterized in that the lever comprises a housing suitable for being fitted around one of the rods and covering the detent ball engagement member, the housing internally comprising the cam in order to serve as an engagement track for the detent ball engagement member and to allow for the indexing of various positions of the lever, and a grid in order to cooperate with the selector finger.
